(19) United States
(12) Patent Application Publication
(10) Pub. No.: US 2016/0150815 A1
(43) Pub. Date: Jun. 2, 2016

(54) SALT BASED DRYING BRINING INSTRUMENT

(71) Applicant: Salt Rox, LLC, Lexington, KY (US)

(72) Inventors: John R. Tucker, Jr., Lexington, KY (US); Mary Porter McKee, Lexington, KY (US)

(73) Assignee: Salt Rox, LLC, Lexington, KY (US)

(21) Appl. No.: 14/955,870

(22) Filed: Dec. 1, 2015

Related U.S. Application Data
(60) Provisional application No. 62/085,901, filed on Dec. 1, 2014.

(51) Int. Cl. A23P 1/08; F24C 7/08

(52) U.S. Cl. CPC A23P 1/082; F24C 7/08

(57) ABSTRACT

A method of making a dry brining instrument includes inspecting a halite for use as a dry brining instrument to identify a defect in the halite, shaping the halite to a desired shape to form the dry brining instrument, wherein the desired shape is determined based on a food item in which the dry brining instrument will be at least partially inserted, polishing an exterior portion of the dry brining instrument, and heat treating the dry brining instrument according to a predetermined heating schedule, to strengthen the integrity of the dry brining instrument to temperature cycling through repeated use.

### CROSS REFERENCE TO RELATED APPLICATIONS

The present application hereby claims the benefit of Provisional U.S. Application No. 62/085,901 filed Dec. 1, 2014, titled “HIMALAYAN SALT BASED PRODUCT FOR BRINING POULTRY.”

### BACKGROUND

Historically, food items are brined through submersing the food item in a bath of water with seasoning and other spices for a duration of time before cooking. This process takes time, preplanning, is difficult, and is messy. Thus, a need exists in the industry.

### SUMMARY

In one embodiment, a method for making a dry brining instrument may include inspecting a halite for use as a dry brining instrument to identify a defect in the halite, shaping the halite to a desired shape to form the dry brining instrument, wherein the desired shape is determined based on a food item in which the dry brining instrument will be at least partially inserted, polishing an exterior portion of the dry brining instrument, and heat treating the dry brining instrument according to a predetermined heating schedule, to strengthen the integrity of the dry brining instrument to temperature cycling through repeated use.

In another embodiment, a dry brining instrument may include a body of halite wherein the body is shaped to provide surface contact between the body and a cavity of a food item when the dry brining instrument is at least partially reside in the cavity and the body is heat treated to withstand cooking temperatures up to about 700 degrees Celsius.

In yet another embodiment, a brining kit may include a dry brining instrument and secondary seasoning wherein the dry brining instrument comprises a body of halite and the body is shaped to provide surface contact between the body and a cavity of a food item when the dry brining instrument is at least partially reside in the cavity. The body is heat treated to strengthen integrity of the dry brining instrument to strengthen the integrity of the dry brining instrument to temperature cycling through repeated use, and the secondary seasoning is configured to cover the dry brining instrument prior to at least partial insertion of the dry brining instrument in a food item.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and not intended to limit the subject matter defined by the claims. The following detailed description of the illustrative embodiments can be understood when read in conjunction with the following drawings, where like structure is indicated with like reference numerals and in which:

FIG. 1 depicts a top view of a dry brining instrument according to one or more embodiments shown and described herein;

FIG. 2 depicts a cross-sectional view of the dry brining instrument according to one or more embodiments shown and described herein;

FIG. 3 depicts an exploded view of the dry brining instrument used with a rotisserie spit according to one or more embodiments shown and described herein;

FIG. 4 depicts the dry brining instrument in a cavity of a food item according to one or more embodiments shown and described herein;

FIG. 5 depicts a stand for use with the dry brining instrument according to one or more embodiments shown and described herein;

FIG. 6 depicts a top view of another embodiment of a dry brining instrument according to one or more embodiments shown and described herein;

FIG. 7 depicts a cross-sectional view of the dry brining instrument in FIG. 6 according to one or more embodiments shown and described herein; and

FIG. 8 depicts a flowchart of making the dry brining instrument according to one or more embodiments shown and described herein.

### DETAILED DESCRIPTION

Embodiments disclosed herein include a method, a dry brining instrument, and a brining kit for cooking food. Some embodiments include a dry brining instrument made from halite, which may be embodied as a form of salt rock. The dry brining instrument may be pre-heated and inserted into a cavity of a food item prior to and/or during cooking to produce a food item that has a texture, consistency, and taste of a similar food item that was submerged in a brine solution prior to cooking. The dry brining instrument may include a through bore that may allow for manipulation of the dry brining instrument. The dry brining instrument is easily cleaned and stored until its next use. Various embodiments of the dry brining instrument and the operation of the dry brining instrument will be described in more detail herein.

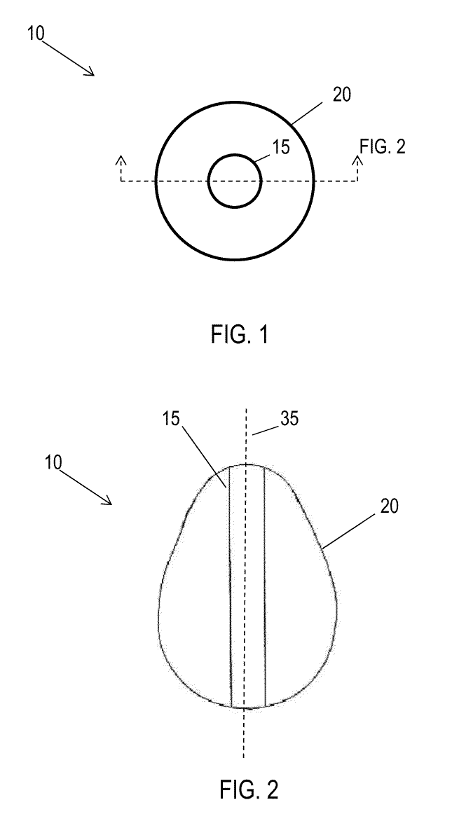

Referring now to the drawings, FIG. 1 depicts a top view of a dry brining instrument 10. The dry brining instrument comprises a body 20 of halite. Halite is the mineral form of sodium chloride (NaCl) and is commonly known as rock salt. Halite is typically white but may include other colors such as light blue, dark blue, purple, pink, red, orange, yellow, or gray. The color may be substantially translucent or substantially opaque. In some embodiments, the halite is colorless. The dry brining instrument 10 may take on any shape or size as desired. For example, and not by way of limitation, the body 20 of the dry brining instrument 10 may be a ball shape, an egg shape, a cylindrical shape, a cone shape, a spherical shape or other regular or amorphous shape. Similarly, some embodiments may be configured such that the halite is granulated and provided in a permeable sack or bag. It is contemplated that the size and shape of the body 20 of the dry brining instrument 10 is tailored for the food item in which the dry brining instrument 10 is to be at least partially inserted or at least partially placed within the food item to increase the percentage of surface contact between the dry brining instrument 10 and the food item.

Similarly, some embodiments may be configured such that the body 20 of the halite is granulated and provided in a permeable sack or bag. In this embodiment, the permeable sack or bag is at least partially filled with granulated halite and at least partially inserted or resides within a cavity of a food item. The permeable sack or bag with granulated halite is preheated and used as described hereinafter in relation to the disclosure of the dry brining instrument 10. The permeable sack or bag may be shaped to provide surface contact between the body and a cavity of a food item. It is contemplated that the permeable sack or bag may be shaped by hand or by construction of the permeable sack or bag.

The halite for the body 20 may be mined from areas of high salt content to include areas within the United States. For example, and not by way of limitation, the body 20 may be made from Himalayan salt mined as slabs of stone from the Himalayan Mountain region and may have a pink marbled coloring. The salt content of halite allows for a small quantity of salt to transfer to the cavity of the food item during cooking. The flavor imparted in a food item from a dry brining instrument made from Himalayan Salt is mild when compared to a processed sodium product. A trace of minerals in the Himalayan salt may impart a mild and complex taste to the food item. In one embodiment, a body 20 of Himalayan salt may comprise about 1.2% sulfur by volume, about 4% calcium by volume, about 0.35% potassium by volume, about 16% magnesium by volume, along with about 80 other trace minerals.

In one embodiment, as shown in FIG. 2, the body 20 of the dry brining instrument 10 is an egg shape. The egg shape imparts several features to the dry brining instrument 10. For example, the egg shape does not allow the dry brining instrument 10 to roll in a straight line. Instead, the dry brining instrument 10 will roll in a circular path when placed upon a flat surface. This may prevent the dry brining instrument 10 from rolling off a countertop and the like. Further, the egg shape reduces the effort needed for the dry brining instrument 10 to be inserted and removed from a cavity of a food item such as poultry. The size may be tailored for specific sized cavity. For example, if the food item is a turkey, a larger dry brining instrument 10 may be used to allow for sufficient surface contact between the body 20 of the dry brining instrument 10 and the cavity walls of the turkey. A smaller dry brining instrument 10 may be used for a hen.

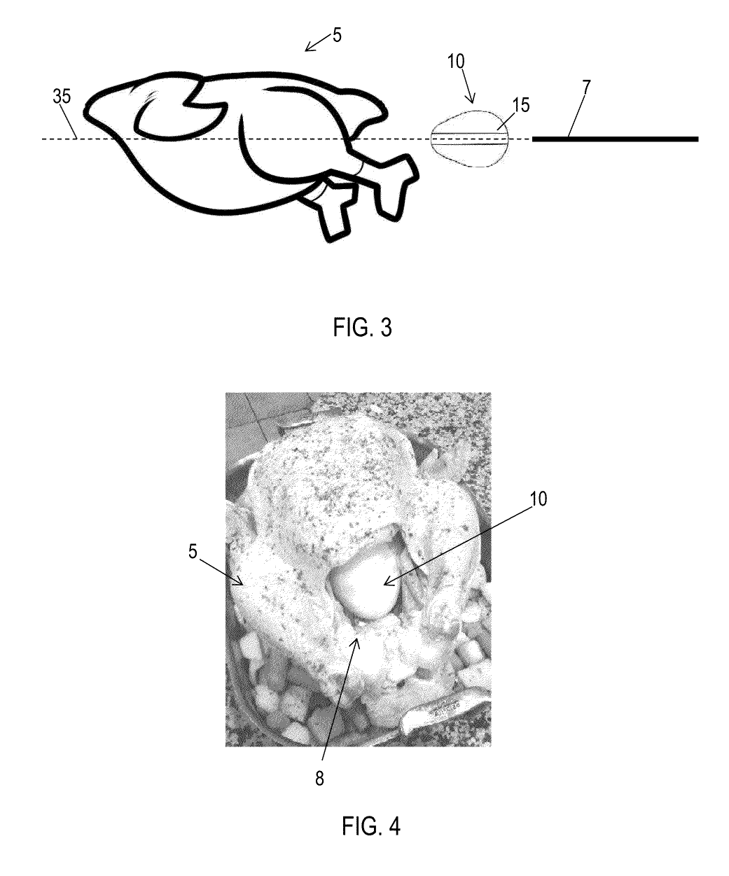

Still referring to the cross-section of FIG. 2, the dry brining instrument 10 may include a through bore 15 in the body 20 of the dry brining instrument 10. The through bore 15 may be centered along a central axis 35 of the body 20. The through bore 15 is shown in FIG. 2 as a cylinder, however, it should be understood that the through bore 15 may be of any shape. For example, the through bore 15 may be a rectangular shape, a conical shape, a hemispherical shape, or other shape as needed for the desired application. It is contemplated that the through bore 15 may allow the dry brining instrument 10 to be hung to dry after use or, referring to FIG. 3, allow for a rotisserie spit 7 to be inserted through the dry brining instrument 10 and the food item 5 along the central axis 35 in which the dry brining instrument 10 is at least partially inserted. Additionally, some embodiments may include a through bore 15 with notches for allowing a removal tool to be inserted into the through bore 15 and catch one of the notches for easily removing the brining instrument 10.

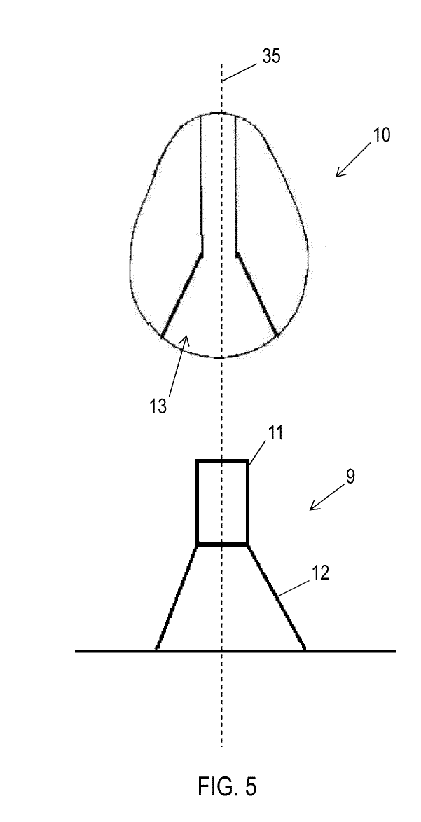

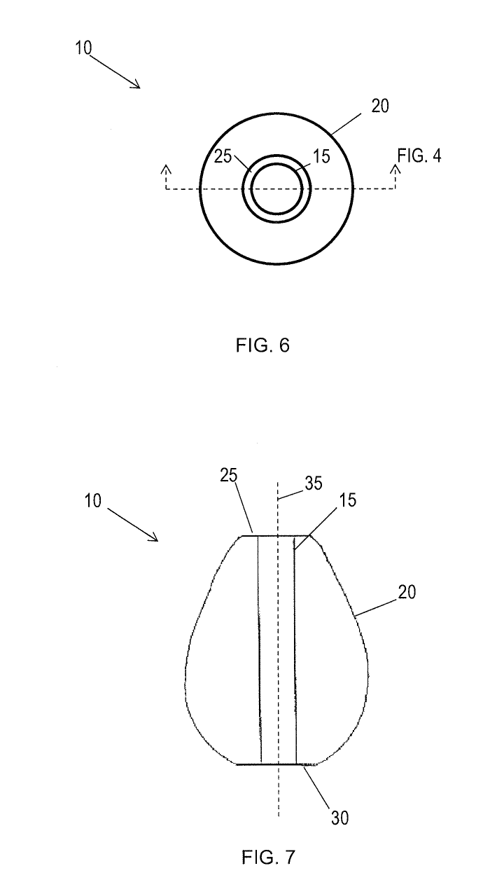

FIG. 4 illustrates the dry brining instrument 10 in the body cavity 8 of a food item 5 such as poultry. It is contemplated that the dry brining instrument 10 may be used with any meat product in which the dry brining instrument 10 may at least partially reside during cooking. It is noted that the dry brining instrument 10 of FIG. 4 does not have a through bore 15 as shown in FIG. 2. If a through bore 15 was present, the through bore 15 may allow juices, oils, etc., from the cavity of the food item to exit and/or allow convection to occur within cavity. The through bore 15 may also aid in reducing the likelihood of cracking or fracturing of the dry brining instrument 10 due to thermal stresses of cooking. In other words, the through bore 15 provides a relief from thermal expansion and contraction of the dry brining instrument 10.

The through bore 15 may also be used to aid in removal of the dry brining instrument 10 from a cavity of the food item 5. A tool such as a dow rod may be inserted into the through bore 15 to leverage the dry brining instrument 10 from a food item. In another embodiment, the through bore 15 may be used to orient the dry brining instrument 10 and concurrently a food item in specific orientation for cooking, cooling, and/or preparation for cooking. For example, the through bore 15 may include a threads such that the through bore 15 may rotatably couple with a threaded post (not shown) to orient the dry brining instrument 10 in an upright position. The combination of the threaded post and the threads may also aid in positioning the dry brining instrument 10 within the cavity and/or removing the dry brining instrument 10 from the cavity of a food item.

Referring to FIG. 5, it is also contemplated that the shape of the through bore 15 may be tailored to removably couple with a stand 9. The stand 9 may align with the dry brining instrument 10 along the central axis 35 and may include a post section 11 and/or an alignment section 12. The through bore 15 may include an alignment surface 13 which may mirror the alignment section 12 in construction such that the stand 9 and dry brining instrument 10 align and provide for a secure coupling between the dry brining instrument 10 and stand 9 to maintain the desired orientation of the dry brining instrument 10 and/or food item.

FIG. 6 is a top view of another embodiment of the dry brining instrument 10. In this embodiment, the body 20 may include an upper surface 25 and a lower surface 30 (FIG. 7), both of which define a set of planes that are about orthogonal to the central axis 35 (FIG. 7). Referring to FIG. 7, the upper surface 25 and the lower surface 30 may aid in preventing cracking of the dry brining instrument 10 by eliminating any points or other edges of the dry brining instrument 10. The upper surface 25 and the lower surface 30 may also prevent the dry brining instrument 10 from rolling and/or moving along a surface upon which it is placed when seating on either the upper surface 25 or the lower surface 30. In one embodiment, either the upper surface 25 or the lower surface 30 may be used to orient the dry brining instrument 10 in an upright position as shown in FIG. 7 to aid in placing the dry brining instrument 10 within the cavity of a food item, to heat up the dry brining instrument 10 in an oven, or cool off the dry brining instrument 10 after cooking.

Halite may, once heated, retain and radiate heat for an extended quantity of time after the removal of the heat source. When used as an aid in cooking a food item, the dry brining instrument 10 may be preheated prior to insertion in a cavity of a food item. For example, the dry brining instrument 10 may be preheated to between about 200 degrees Celsius to about 350 degrees Celsius for about 20-40 minutes. In another embodiment, the dry brining instrument 10 may be preheated to about 204 degrees Celsius for about 30 minutes. The dry brining instrument 10 may then be carefully inserted into the cavity of the food item or positioned to reside within the food item. The through bore 15 may be axially aligned with the cavity of the food item or aligned such that there is a large percentage of surface area contact between the body 20 of the dry brining instrument and surface of the cavity. The food item is then cooked at a predetermined temperature for a predetermined duration of time or until the food item reaches the recommended internal temperatures. When cooking is complete, the dry brining instrument 10 may be removed from the food item and allowed to cool. As explained hereinbefore, the through bore 15 may be used to remove the dry brining instrument 10 from the food item. In some embodiments, a tool, such as tongs, may be used in conjunction with the through bore 15 to remove the dry brining instrument 10 from the food item. If the dry brining instrument includes the upper surface 25 and/or the lower surface 30 as shown in FIG. 7, they may be used to restrict the movement of the dry brining instrument 10 on a surface to cool. Once cool to the touch, the dry brining instrument 10 may be brushed clean, patted dry with a cloth or paper product, and stored until used again.

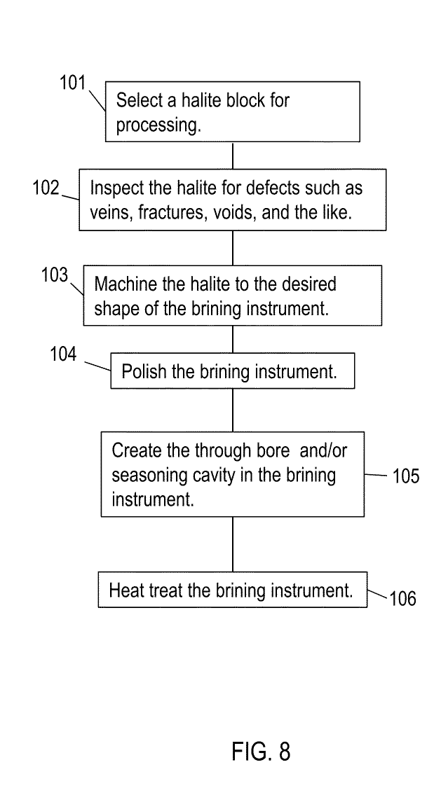

Referring to FIG. 8, typically the mined halite (i.e., salt stone) blocks are fragile depending on the veining within the halite block and are usually selected from the quarry by hand. A very high quality salt stone may be selected 101 in order to create a dry brining instrument 10 free of defects, such as fractures, veins, fissures, voids, and the like. In order to identify this type of salt stone, a bright light inspection 102 process may be used to visually identify any defects such as internal veins, fractures, fissures, voids, veins, or the like. The light inspection process may include, either by human eye or sensors, shining a bright light through the halite block and identifying any defects. The light inspection process may also include marking the halite block to note which areas are free from defects.

Once the salt stones are identified and selected and defects are noted, they are machined 103 to the desired shape of the dry brining instrument 10. For example, the salt stone may be cut into salt blocks that are suitable for a lathe. In one embodiment, a diamond wet saw is used to cut the salt blocks into the appropriate size. The salt block is placed into a lathe in order to create the outer shape of the body 20 of the dry brining instrument 10. In addition to the lathe, a diamond tipped gauge may be used to make the cut necessary to shape the salt block. Specifically, the salt block is centered in between the chuck and the drive head of the lathe. Once the lathe is turning, a gauge is placed on the rest of the lathe and additional salt is shaved off the salt block to produce the desired shape and size of the dry brining instrument 10. Once shaped appropriately, the exterior portion (i.e., the surface of the body 20) of the dry brining instrument 10 is polished 104 with a 220 grit sandpaper to smooth out the sides and to round the edges for appearance. Once the smoothing/polishing process is complete, the dry brining instrument 10 is removed from the lathe. As an alternative, if desired, the dry brining instrument 10 is placed into a padded vice and the through bore 15 is created 105 in the body 20 with a carbide grit hole saw. It is contemplated that the through bore 15 may also be created with a hydro cutting device and the like.

Once the dry brining instrument 10 has been formed, the dry brining instrument 10 may be heat treated 106 according to a predetermined heating schedule to increase strengthen the integrity of the dry brining instrument 10 to temperature cycling through repeated use and withstand elevated cooking temperatures without fracturing. The predetermined heating schedule may include heating the dry brining instrument 10 in a kiln or the like to between about 1000 degrees Celsius and about 500 degrees Celsius. The dry brining instrument 10 is held at the desired temperature for a predetermined duration of time. For example, and not by limitation, the dry brining instrument 10 may be held at about 700 degrees Celsius for about 10 to about 14 hours. After the duration of time has expired, the heat within the kiln is reduced in increments over a cool down period of time to room temperature. For example, the dry brining instrument 10 may be cooled to room temperature over a period of 24 hours in increments of 100 degrees Celsius. During the heat treating 106 process, the dry brining instrument 10 may change from substantially translucent to substantially opaque.

In some embodiments, the dry brining instrument 10 may be part of a dry brining kit with secondary seasoning being provided to augment the salt of the dry brining instrument 10. As such, the body 20 of the dry brining instrument 10 may be covered by the secondary seasoning prior to inserting the dry brining instrument 10 into a cavity of a food item. In another embodiment, the through bore 15 may be used to secure secondary seasoning within the dry brining instrument 10. It yet another embodiment, the dry brining instrument 10 may include a seasoning cavity, such as that created by the alignment surface 13 shown in FIG. 5. The secondary seasoning may be inserted into the seasoning cavity instead of the through bore 15. The juices, oils, etc., from the food item in which the dry brining instrument 10 resides may mix with the brining seasoning and transfer additional flavor to the food item.

As illustrated above, various embodiments of the dry brining instrument 10 are disclosed. The dry brining instrument 10 may cut cooking time of the food item and replicate a salt brine submersion cooking style without the need to actually submerge the food item in a salt brine. The dry brining instrument 10 may be naturally anti-microbial and easy to maintain by cleaning with a brush, patting to dry, and storing until its next use.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It is also noted that terms like “preferably,” “commonly,” and “typically” are not utilized herein to limit the scope of the appended claims or to imply that certain features are critical, essential, or even important to the structure or function of the claimed subject matter. Rather, these terms are merely intended to highlight alternative or additional features that may or may not be utilized in a particular embodiment.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of making a dry brining instrument comprising:
inspecting a halite for use as a dry brining instrument to identify a defect in the halite;
shaping the halite to a desired shape to form the dry brining instrument, wherein the desired shape is determined based on a food item in which the dry brining instrument will be at least partially inserted;
polishing an exterior portion of the dry brining instrument; and
heat treating the dry brining instrument according to a predetermined heating schedule, to strengthen the integrity of the dry brining instrument to temperature cycling through repeated use.

2. The method of claim 1 comprising creating a through bore along a central axis of the dry brining instrument after polishing.

3. The method of claim 1 comprising creating a seasoning cavity in the dry brining instrument after polishing.

4. The method of claim 1 wherein the desired shape includes at least one of the following: an egg shape, a ball shape, a spherical shape, and a triangular shape.

5. The method of claim 1 wherein heat treating the dry brining instrument includes heating treating the dry brining instrument at about 700 degrees Celsius.

6. The method of claim 1 wherein the dry brining instrument is at least one of the following: pink in color, blue in color, white in color, substantially translucent, and substantially opaque.

7. The method of claim 1 wherein the dry brining instrument includes Himalayan rock salt.

8. The method of claim 1 wherein treating comprises:
heating the dry brining instrument in a kiln to an elevated temperature;
maintaining the elevated temperature for a duration of time; and
reducing the heat in increments over a cool down period of time to room temperature after the duration of time has expired.

9. The method of claim 1 wherein light is projected through the halite during the inspection process to identify defects in the halite.

10. A dry brining instrument comprising a body of halite wherein:
the body is shaped to provide surface contact between the body and a cavity of a food item when the dry brining instrument is at least partially reside in the cavity; and
the body is heat treated to withstand cooking temperatures up to about 700 degrees Celsius.

11. The dry brining instrument of claim 10 wherein the body is shaped to prevent the dry brining instrument from rolling in a substantially straight line.

12. The dry brining instrument of claim 10 wherein the body comprises at least one of an upper surface and a lower surface, the upper surface and the lower surface are substantially orthogonal to a central axis of the dry brining instrument and maintain the dry brining instrument in a substantially upright position when placed on a flat surface.

13. The dry brining instrument of claim 10 wherein the body comprises a permeable bag at least partially filled with granulate halite.

14. The dry brining instrument of claim 10 wherein the body comprises a through bore along a central axis of the body.

15. The dry brining instrument of claim 14 wherein the through bore removable couples with a tool to remove the dry brining instrument from the cavity of the food item.

16. The dry brining instrument of claim 14 wherein the through bore removable couples with a rotisserie spit.

17. The dry brining instrument of claim 10 wherein the body comprises an alignment surface removably couples with a stand to support the dry brining instrument in a substantially upright orientation.

18. The dry brining instrument of claim 17 wherein the alignment surface and the stand support the dry brining instrument and a food item in a substantially upright orientation when the dry brining instrument is partially inserted into a food item.

19. A dry brining kit comprising a dry brining instrument and secondary seasoning wherein:
the dry brining instrument comprises a body of halite;
the body is shaped to provide surface contact between the body and a cavity of a food item when the dry brining instrument is at least partially reside in the cavity;
the body is heat treated to strengthen integrity of the dry brining instrument to strengthen the integrity of the dry brining instrument to temperature cycling through repeated use;
and the secondary seasoning is configured to cover the dry brining instrument prior to at least partial insertion of the dry brining instrument in a food item.

20. The dry brining kit of claim 19 wherein the dry brining instrument comprises a through bore along a central axis of the body and the secondary seasoning is inserted into the through bore of the dry brining instrument.
